(19) United States
(12) Patent Application Publication
(10) Pub. No.: US 2009/0122051 A1
(43) Pub. Date: May 14, 2009

(54) Plasma display device and driving method thereof

(76) Inventor: Joo-Yul Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/289,464

(22) Filed: Oct. 28, 2008

(30) Foreign Application Priority Data
Nov. 14, 2007 (KR) 10-2007-0116129

(51) Int. Cl. G06F 3/038

(52) U.S. Cl. 345/212

(57) ABSTRACT

The plasma display device includes a plurality of discharge cells, a controller, and a driver. The controller is configured to divide one frame into a plurality of subfields each having a weight value, determine a sustain number allocated to one frame according to a screen load ratio calculated based on video signals inputted for a duration of a frame, allocate the sustain number allocated for one frame to the subfields, and set a minimum sustain number allowed at each screen load ratio and a target sustain number at each screen load ratio. The driver is configured to apply sustain pulses of as many as the sustain number allocated to each subfield to the discharge cells in each subfield. Whenever a first screen load ratio of a current frame is smaller than a second screen load ratio of a previous frame coming right before the current frame, the controller determines a starting point according to a sustain number of the previous frame and the sustain number of the first screen load ratio, and gradually increases the sustain number of the first screen load ratio from the starting point to the target sustain number of the first screen load ratio through subsequent frames.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filed in the Korean Intellectual Property Office on the 14 Nov. 2007 and there duly assigned Serial No. 10-2007-0116129.

### BACKGROUND OF THE INVENTION

1. Field of the Invention

The present invention relates to a plasma display device and a driving method thereof. More particularly, the present invention relates to a plasma display device that controls the number of sustain pulses and a driving method thereof.

2. Description of the Related Art

Plasma display devices have a characteristic that power consumption and voltage applied to a driving circuit vary according to displayed images. To prevent the power consumption from being out of a safe operation area (SOA), the plasma display device performs automatic power control (APC). When screen load ratio increases, power consumption increases as well. Thus, when the screen load ratio increases, the automatic power control is performed in such a manner that the number of sustain pulses is reduced to maintain the power consumption in the safe operation area.

Here, images displayed on the plasma display device may be changed as fast as moving pictures.

When a screen of a high screen load ratio is changed to a screen of a low screen load ratio, the number of sustain pulses may increase abruptly to thereby increase luminance suddenly. The sudden increase in the luminance decreases image quality, and human eyes may feel uncomfortable with the screen.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display device having an advantage of causing smooth screen switching by controlling driving power, and a driving method thereof.

An exemplary embodiment of the present invention provides a driving method of a plasma display device that displays video by performing sustain discharge as many times as a sustain number allocated to a frame, and stores a minimum sustain number and target sustain number for a screen load ratio. The method includes steps of calculating a first screen load ratio of a first frame that immediately follows a second frame, determining a starting point of a sustain number based on a minimum sustain number at the first screen load ratio and a sustain number of the second frame if the first screen load ratio is smaller than a screen load ratio of the second frame, and increasing a sustain number from the starting point towards a target sustain number of the first screen load ratio through at least one subsequently following frame.

Another embodiment of the present invention provides a plasma display device including a plurality of discharge cells for generating light, a controller, and a driver. The controller is configured to divide one frame into a plurality of subfields each having a weight value, to determine a sustain number allocated to one frame according to a screen load ratio calculated based on video signals inputted for duration of a frame, to allocate the sustain number allocated for one frame to the subfields, and to set a minimum sustain number allowed at each screen load ratio and a target sustain number at each screen load ratio. The driver is coupled to the controller and is configured to apply sustain pulses of as many as the sustain number allocated to each subfield to the discharge cells in each subfield. The controller performs operations that includes steps of calculating a first screen load ratio of a first frame that immediately follows a second frame, determining a starting point of a sustain number based on a minimum sustain number at the first screen load ratio and a sustain number of the second frame if the first screen load ratio is smaller than a screen load ratio of the second frame, and increasing a sustain number from the starting point towards a target sustain number of the first screen load ratio through at least one subsequently following frame.

Yet another embodiment of the present invention provides a plasma display device that includes a first electrode, a second electrode extending in the same direction as the first electrode, a controller, and a driver. The controller is configured to divide one frame into a plurality of subfields each having a weight value, to determine a sustain number allocated to one frame according to a screen load ratio calculated based on video signals inputted for duration of a frame, to allocate the sustain number allocated for one frame to the subfields, and to set a minimum sustain number allowed at each screen load ratio and a target sustain number at each screen load ratio. The driver is coupled to the controller and is configured to alternately apply sustain pulses to the first electrode and the second electrode. The driver applies sustain pulses of as many as the sustain number allocated to each subfield. The controller performs operations that includes steps of calculating a first screen load ratio of a first frame that immediately follows a second frame, and determining a starting point of a sustain number based on a minimum sustain number at the first screen load ratio and a sustain number of the second frame if the first screen load ratio is smaller than a screen load ratio of the second frame.

According to an embodiment of the present invention, it is possible to reduce an abrupt change in luminance of screens that are changed, and to change the screens smoothly by comparing the number of sustains of video signals before the change with the number of sustains of video signals after the change when video signals are switched to thereby determine the number of sustains at a starting point for increasing the number of sustains, and increasing the number of sustains up to the determined sustain number at the starting point.

Since the number of sustains at the starting point is determined based on the number of sustains before and after the change, the average number of sustains is reduced to thereby decrease power consumption and load on a driving circuit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a plasma display device in accordance with an embodiment of the present invention.

FIG. 2 is a block view showing an internal structure of a controller in accordance with an embodiment of the present invention.

FIG. 3 shows a power consumption area of a plasma display panel (PDP) in accordance with an embodiment of the present invention.

FIG. 4 illustrates an internal structure of an automatic power control (APC) unit in accordance with an embodiment of the present invention.

FIG. 5 is a graph showing the number of sustains according to a screen load ratio in accordance with an embodiment of the present invention.

FIG. 6 is a flowchart describing a process of controlling the number of sustains upon a change in video signals in accordance with an embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, when a certain part “comprises” or “includes” a predetermined constituent element, it does not mean that the part excludes the presence of the other constituent elements but it means that the part may further include other constituent elements, if there is no specific comment otherwise.

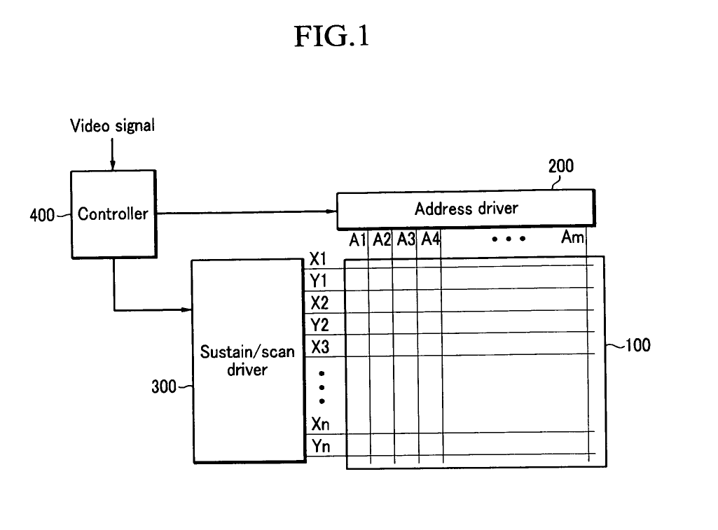

FIG. 1 illustrates a plasma display device in accordance with an embodiment of the present invention. Referring to FIG. 1, the plasma display device according to the present embodiment includes a plasma display panel 100, an address driver 200, a sustain/scan driver 300, and a controller 400.

The plasma display panel 100 includes a plurality of address electrodes A1 to Am arranged in a column direction, and a plurality of scan electrodes Y1 to Yn and sustain electrodes X1 to Xn arranged in a row direction. The address driver 200 receives an address driving control signal from the controller 400, and applies a display data signal for selecting a discharge cell to be displayed to the respective address electrodes A1 to Am. The sustain/scan driver 300 receives a control signal from the controller 400 and alternately inputs sustain pulses having sustain voltages to the scan electrodes Y1 to Yn and the sustain electrodes X1 to Xn to thereby execute sustain discharge for the selected discharge cell.

The controller 400 receives R, G, and B video signals and sync signals from the outside, and divides a frame into a plurality of subfields each having a weight value. Each subfield is divided into a reset period, an address period, and a sustain period to thereby drive a plasma display panel (PDP). Herein, the controller 400 measures a screen load ratio with video signals inputted for one frame, and determines the total number of sustain pulses allocated to one frame according to the screen load ratio (which will be referred to as “sustain number” hereinafter). Then, the controller 400 allocates the sustain pulses to the subfields in such a manner that the entire sustain number is in proportion to the weight value of each subfield, and supplies control signals acquired thereafter to the address driver 200 and the sustain/scan driver 300.

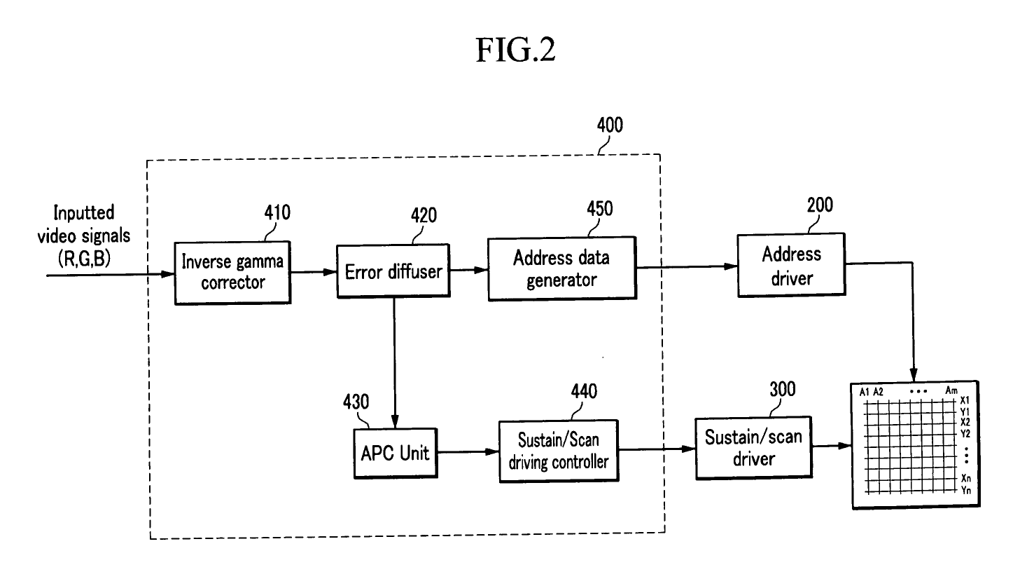

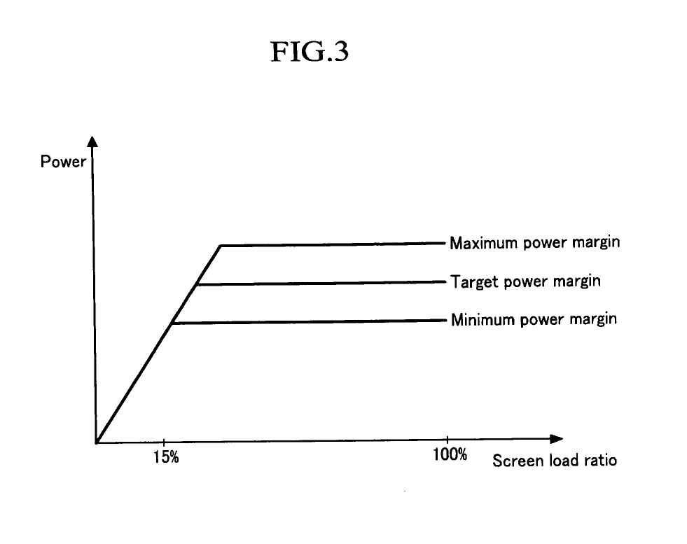

Hereinafter, the controller 400 of a plasma display device will be described in detail in accordance with another embodiment of the present invention with reference to FIG. 2 and FIG. 3.

FIG. 2 is a block view showing an internal structure of a controller in accordance with an embodiment of the present invention. As shown in FIG. 2, the controller 400 of this embodiment includes an inverse gamma corrector 410, an error diffuser 420, an automatic power control (APC) unit 430, a sustain/scan driving controller 440, and an address data generator 450.

The inverse gamma corrector 410 maps n-bit R, G, and B video signals, which are currently inputted to an inverse gamma curve, to thereby correct them into m-bit video signals (men). For example, n may be 8 and m may be 10 or 12.

Herein, the video signals inputted to the inverse gamma corrector 410 are digital signals. If analog video signals are inputted to a plasma display device, the analog video signals need to be converted into digital video signals through an analog-to-digital converter (not shown). The inverse gamma corrector 410 may include a lookup table (not shown) storing data corresponding to the inverse gamma curve for mapping video signals, or a logic circuit (not shown) for generating data corresponding to the inverse gamma curve through logical operations.

The error diffuser 420 performs error diffusion on low-order (m-n) bits into adjacent pixels among bits (m) that are inverse-gamma-corrected and expanded by the inverse gamma corrector 410. Error diffusion is a method of displaying video for the low-order bits by separating video for the low-order bits whose errors are to be diffused and diffusing the errors into adjacent pixels.

Herein, the inverse gamma corrector 410 and the error diffuser 420 may not be used when it is not needed to map inputted video signals to the inverse gamma curve.

The APC unit 430 calculates a screen load ratio by using video data outputted from the error diffuser 420. For example, the APC unit 430 can calculate the screen load ratio based on an average signal level of video signals inputted for the duration of a frame. Herein, the power consumption region of a plasma display device according to the screen load ratio may be set as shown in FIG. 3. As shown in FIG. 3, until the screen load ratio increases up to a threshold value (which is, for example, 15% in FIG. 3), the sustain number is uniformly maintained so that the power increases in proportion to the screen load ratio. When the screen load ratio exceeds the threshold value, the sustain number decreases as the screen load ratio increases so that the power does not exceed a predetermined value. Herein, as the screen load ratio increases, the minimal power consumption that the plasma display device can have is referred to as a minimal power margin, and the maximal power consumption that the plasma display device can have is referred to as a maximal power margin. The level of power consumption that is positioned between the maximal power margin and the minimal power margin, at which the plasma display device can stably operate corresponding to the screen load ratio, is referred to as a target power margin.

Herein, the APC unit 430 stores a sustain number satisfying the maximal power margin for each screen load ratio (which will be referred to as “maximal sustain number”), a sustain number satisfying the minimal power margin for each screen load ratio (which will be referred to as “minimal sustain number”), and a sustain number satisfying the target power margin (which will be referred to as “target sustain number”).

Also, when the screen load ratio of inputted video signals decreases, the APC unit 430 compares the sustain number corresponding to the screen load ratio before and after modification, and determines the sustain number as the starting point for increasing the sustain number based on the comparison result. The APC unit 430 controls the sustain number by increasing the sustain number from the sustain number at the above-determined starting point.

The sustain/scan driving controller 440 allocates the number of sustain pulses of each subfield by using the sustain number information transmitted from the APC unit 330. Then, sustain/scan driving controller 440 generates control signals corresponding to the number of sustain pulses outputted from the APC unit 330 and outputs the control signals to the sustain/scan driver 300.

The address data generator 450 generates address data corresponding to gray scales of video signals outputted from the error diffuser 420, and transmits the generated address data to the address driver 200.

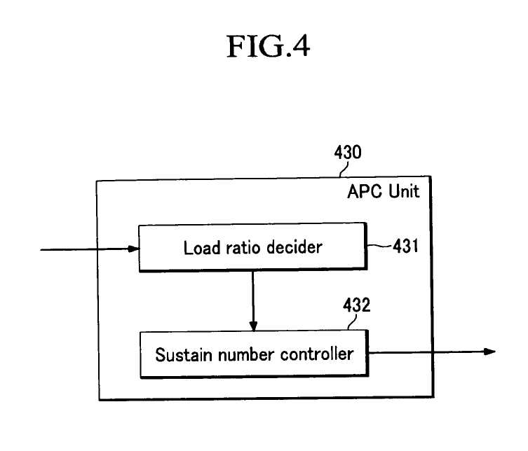

Hereinafter, a method for controlling the sustain number will be described in detail with reference to FIG. 4 to FIG. 6.

FIG. 4 illustrates an internal structure of an automatic power controller (APC) in accordance with an embodiment of the present invention. Referring to FIG. 4, the APC unit 430 includes a load ratio determiner 431 and a sustain number controller 432.

The load ratio determiner 431 calculates the screen load ratio based on the video signals inputted for the duration of a frame. The load ratio determiner 431 controls the sustain number controller 432 when the screen load ratio of a current frame (hereinafter, “current screen load ratio”) is lower than the screen load ratio of a previous frame (hereinafter, “previous screen load ratio”).

If the current screen load ratio is lower than the previous screen load ratio and the minimum sustain number of the current screen load ratio is equal to or smaller than the sustain number of the previous frame, the sustain number controller 432 determines the sustain number of the previous frame as a starting point, and increases the sustain number for each frame until the sustain number reaches a target sustain number of the current screen load ratio. If the current screen load ratio is lower than the previous screen load ratio but the minimum sustain number of the current screen load ratio is greater than the sustain number of the previous frame, the sustain number controller 432 gradually increases the sustain number for each frame from the minimum sustain number of the current screen load ratio until the sustain number reaches a target sustain number.

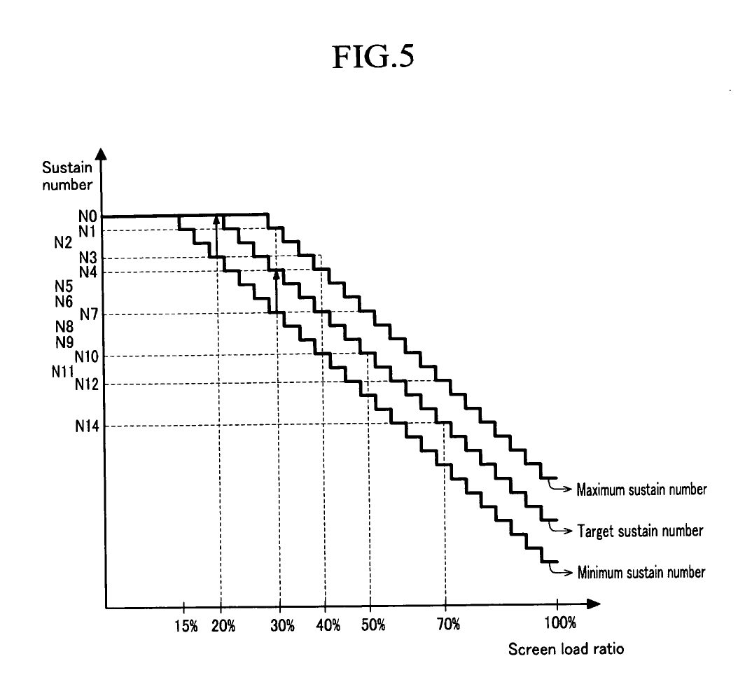

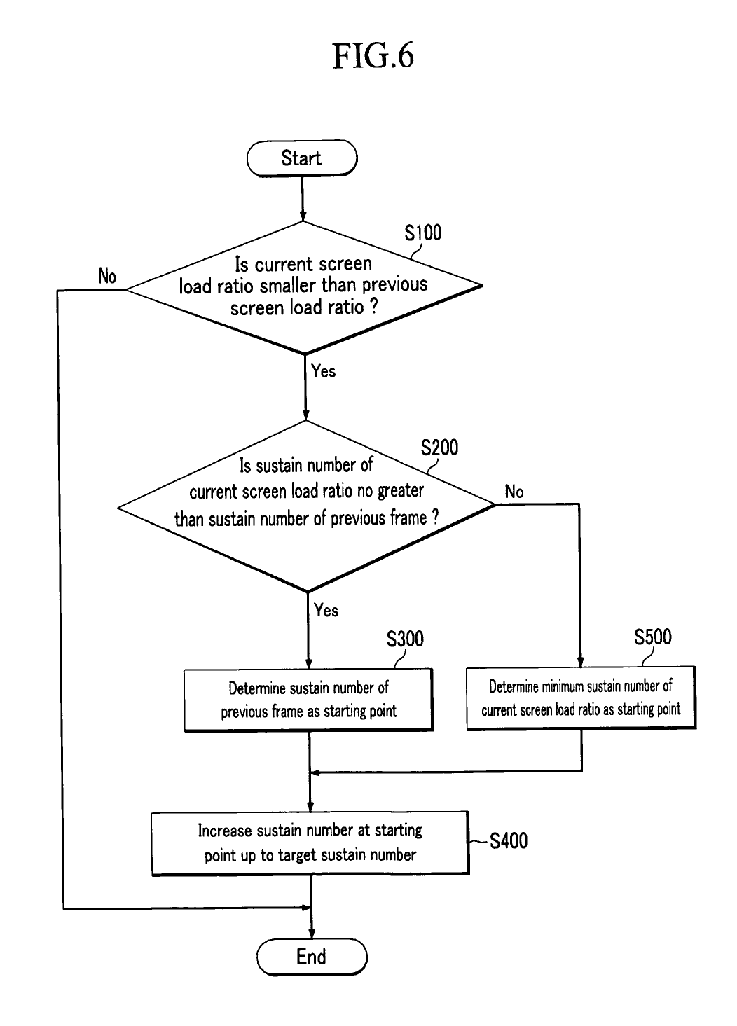

FIG. 5 and FIG. 6 exemplarily describe a method for controlling the sustain number, when a screen with a high screen load ratio is changed to a screen with a low screen load ratio. FIG. 5 is a graph showing the number of sustains according to a screen load ratio in accordance with an embodiment of the present invention, and FIG. 6 is a flowchart describing a process of controlling the number of sustains upon a change in video signals in accordance with an embodiment of the present invention.

At step S100, the load ratio determiner 431 calculates a screen load ratio based on video signals inputted for one frame and determines whether a current screen load ratio is smaller than a previous screen load ratio. If the current screen load ratio is smaller than the previous screen load ratio, the load ratio determiner 431 compares a minimum sustain number of the current screen load ratio with a sustain number of a previous frame at step S200.

If it turns out in the step S200 that the minimum sustain number of the current screen load ratio is equal to or smaller than the sustain number of the previous frame, at step S300, the sustain number controller 432 determines the sustain number of the previous frame as a starting sustain number, that is, as a starting point of the current frame. At step S400, the sustain number controller 432 increases a sustain number through at least one subsequently following frame until the sustain number reaches a target sustain number of the current screen load ratio.

Referring to FIG. 5, for example, the previous screen load ratio and the current screen load ratio are 40% and 30%, respectively. If the sustain number of the previous frame is N7, which is the same as the target sustain number at a screen load ratio of 40%, the sustain number controller 432 sets the starting point of the current frame to be N7. Then, as long as the screen load ratio is uniformly maintained through subsequent frames, the sustain number controller 432 increases the sustain number for each subsequent frame at a predetermined rate until the sustain number reaches the target sustain number N4 of a screen load ratio of 30%.

If it turns out in the step S200 that the minimum sustain number of the current screen load ratio is greater than the sustain number of the previous frame, the sustain number controller 432 determines the minimum sustain number of the current screen load ratio as a starting point of the current frame at step S500. Then, the sustain number controller 432 increases a sustain number for each frame until the sustain number becomes the target sustain number of the current screen load ratio at step S400.

Referring to FIG. 5, for example, if the previous screen load ratio and the current screen load ratio are 40% and 20%, respectively, and the sustain number of the previous frame is N7, which is the same as the target sustain number of a screen load ratio of 40%, the sustain number controller 432 sets the starting point of the current frame to be N3, which is the minimum sustain number of the current screen load ratio. Then, as long as the screen load ratio is uniformly maintained through subsequent frames, the sustain number controller 432 increases the sustain number for each frame at a predetermined rate until the sustain number reaches the target sustain number N0 of a screen load ratio of 20%.

Herein, if the screen load ratio decreases while the sustain number increases through subsequent frames, the sustain number controller 432 returns to the step S200.

As described above, in order to smoothly change the luminance of the screen while video are being displayed, a starting point is determined by comparing the minimum sustain number of the current screen load ratio with the sustain number of the previous frame, and the sustain number is gradually increased through frames at a certain rate until the sustain number at the determined starting point becomes a target sustain number, instead of immediately increasing the sustain number from the sustain number of a previous frame to the target sustain number of the current screen load ratio.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for driving a plasma display device that displays video by performing sustain discharge as many times as a sustain number allocated to a frame and stores a minimum sustain number and target sustain number for a screen load ratio, the method comprising:
calculating a first screen load ratio of a first frame that immediately follows a second frame;
determining a starting point of a sustain number based on a minimum sustain number at the first screen load ratio and a sustain number of the second frame if the first screen load ratio is smaller than a screen load ratio of the second frame; and
increasing a sustain number from the starting point towards a target sustain number of the first screen load ratio through at least one subsequently following frame.

2. The method of claim 1, wherein the determining a starting point includes selecting the starting point from a point between the minimum sustain number at the first screen load ratio and the sustain number of the second frame.

3. The method of claim 1, wherein the determining a starting point includes determining the sustain number of the second frame as the starting point if the minimum sustain number at the first screen load ratio is equal to or smaller than the sustain number of the second frame.

4. The method of claim 1, wherein the determining a starting point includes determining the minimum sustain number at the first screen load ratio as the starting point if the minimum sustain number at the first screen load ratio is greater than the sustain number of the second frame.

5. The method of claim 1, wherein the calculating a first screen load ratio includes determining an average signal level of video signals inputted for duration of the first frame as the first screen load ratio.

6. A plasma display device, comprising:
a plurality of discharge cells for generating light;
a controller that divides one frame into a plurality of subfields each having a weight value, determines a sustain number allocated to one frame according to a screen load ratio calculated based on video signals inputted for duration of a frame, allocates the sustain number allocated for one frame to the subfields, and sets a minimum sustain number allowed at each screen load ratio and a target sustain number at each screen load ratio; and
a driver coupled to the controller, the driver applying sustain pulses of as many as the sustain number allocated to each subfield to the discharge cells in each subfield, wherein the controller performs operations comprising:
calculating a first screen load ratio of a first frame that immediately follows a second frame;
determining a starting point of a sustain number based on a minimum sustain number at the first screen load ratio and a sustain number of the second frame if the first screen load ratio is smaller than a screen load ratio of the second frame; and
increasing a sustain number from the starting point towards a target sustain number of the first screen load ratio through at least one subsequently following frame.

7. The plasma display device of claim 6, wherein:
the controller determines the sustain number of the second frame as the starting point if the minimum sustain number at the first screen load ratio is equal to or smaller than the sustain number of the second frame, and
the controller determines the minimum sustain number at the first screen load ratio as the starting point if the minimum sustain number at the first screen load ratio is greater than the sustain number of the second frame.

8. The plasma display device of claim 6, wherein a greater value between the minimum sustain number at the first screen load ratio and the sustain number of the second frame is determined as the starting point.

9. A plasma display device, comprising:
a first electrode;
a second electrode extending in the same direction as the first electrode;
a controller that divides one frame into a plurality of subfields each having a weight value, determines a sustain number allocated to one frame according to a screen load ratio calculated based on video signals inputted for duration of a frame, allocates the sustain number allocated for one frame to the subfields, and sets a minimum sustain number allowed at each screen load ratio and a target sustain number at each screen load ratio; and
a driver coupled to the controller, the driver alternately applying sustain pulses to the first electrode and the second electrode, the driver applying sustain pulses of as many as the sustain number allocated to each subfield, wherein the controller performs operations comprising:
calculating a first screen load ratio of a first frame that immediately follows a second frame; and
determining a starting point of a sustain number based on a minimum sustain number at the first screen load ratio and a sustain number of the second frame if the first screen load ratio is smaller than a screen load ratio of the second frame.

10. The plasma display device of claim 9, wherein the controller increases a sustain number from the starting point towards a target sustain number of the first screen load ratio through at least than one subsequently following frame.
